(19) United States
(12) Patent Application Publication
(10) Pub. No.: US 2009/0277057 A1
(43) Pub. Date: Nov. 12, 2009

(54) Sound sensing toy

(75) Inventors: Junichi Nagaoka, Tokyo (JP); Shinya Saito, Tokyo (JP)

Correspondence Address: STAAS & HALSEY LLP, SUITE 700, 1201 NEW YORK AVENUE, N.W., WASHINGTON, DC, 20005, US

(73) Assignee: TOMY COMPANY, LTD., Tokyo (JP)

(21) Appl. No.: 12/453,393

(22) Filed: May 8, 2009

(30) Foreign Application Priority Data
May 9, 2008 (JP) 2008-122859

(51) Int. Cl. G09F 19/08

(52) U.S. Cl. 40/411

(57) ABSTRACT

Disclosed is a sound sensing toy including: a plant model including a flower provided with a plurality of petals in a radial shape on a side circumferential face of a substantial circular board shaped center section; a sound sensing section to sense external sound; a control section to perform predetermined control according to sound sensed by the sound sensing section; and a light emitting section provided on the plant model and including a light emitting body and light guiding plate to perform predetermined light emission by control of the control section, wherein the light emitting section is structured so that a light from the light emitting body enters from a side face of the light guiding plate and exits from a front face side of the petal; and the control section controls the light emitting section to emit light in a predetermined light emitting pattern.

### BACKGROUND OF THE INVENTION

1. Field of the Invention

The present invention relates to a sound sensing toy.

2. Description of Related Art

Conventionally, there is known a sound sensing toy which senses external sound and performs a predetermined motion according to the sound. As such a toy, for example, there is a well known Flower Rock (product name) which is a doll representing a plant which starts dancing when the external sound sensed by the sound sensor (sound sensing section) is at or larger than an audible band (for example, Japanese Patent Application Laid-Open Publication No. H3-146084).

In the sound sensing toy as described above, there is a demand for not only motion in response to external sound but also for example, a light emitting body provided on the toy main body to emit light in a predetermined pattern responding to external sound, so that the variation of entertainment increases to enhance interest.

However, there is a problem that in order to make the light emission interesting, the amount of light emission needs to be increased, requiring many light emitting bodies, wiring to connect these bodies, etc. and thus, the cost of manufacturing increases.

### SUMMARY OF THE INVENTION

The present invention has been made in consideration of the above situation, and it is one of main objects to provide a sound sensing toy which enhances interest at a low cost.

According to a first aspect of the present invention, there is provided a sound sensing toy including:

a plant model in a shape of a plant including a flower provided with a plurality of petals in a radial shape on a side circumferential face of a substantial circular board shaped center section;

a sound sensing section to sense external sound;

a control section to perform predetermined control according to sound sensed by the sound sensing section; and

a light emitting section provided on the plant model and including a light emitting body and light guiding plate to perform predetermined light emission by control of the control section, wherein

the light emitting section is structured with the light emitting body provided on a base portion of the petal and the light guiding plate provided on the petal so that a light from the light emitting body enters from a side face of the light guiding plate and exits from a front face side of the petal; and

the control section controls the light emitting section to emit light in a predetermined light emitting pattern according to the sound sensed by the sound sensing section.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, and wherein:

FIG. 1 is a front view showing a sound sensing toy;

FIG. 2 is an exploded perspective view of a plant model;

FIG. 3 is a cross-section view showing the cross-section along arrows A-A shown in FIG. 1;

FIG. 4 is a cross-section view showing the cross-section along arrows B-B shown in FIG. 1; and

FIG. 5 is a block diagram showing a control structure of the sound sensing toy.

### DESCRIPTION OF THE PREFERRED EMBODIMENTS

An embodiment of the present invention will be described below with reference to the drawings.

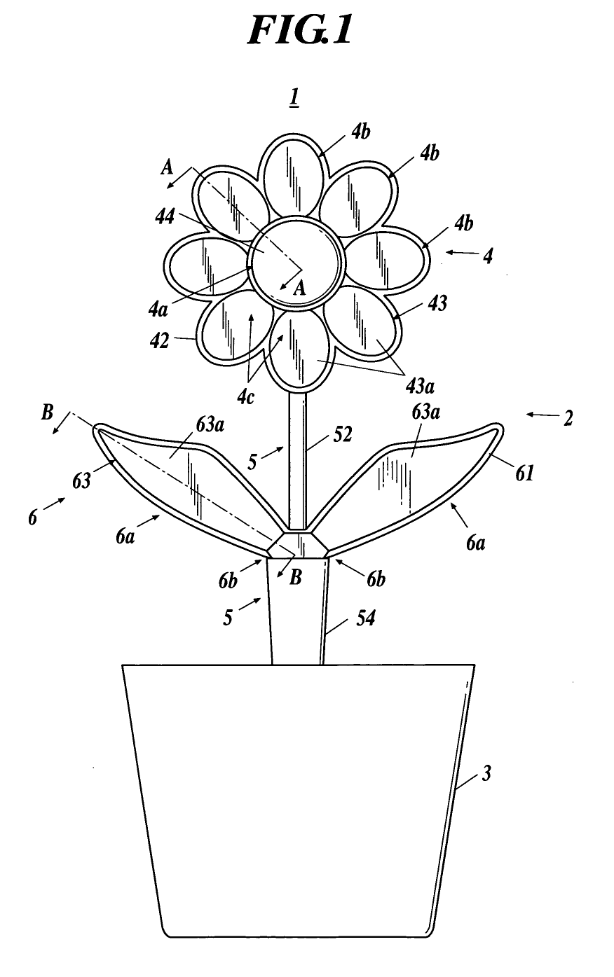

As shown in FIG. 1, the sound sensing toy 1 of the present embodiment includes a plant model 2 representing a plant with a flower and a base 3 in a flowerpot shape to support the plant model 2.

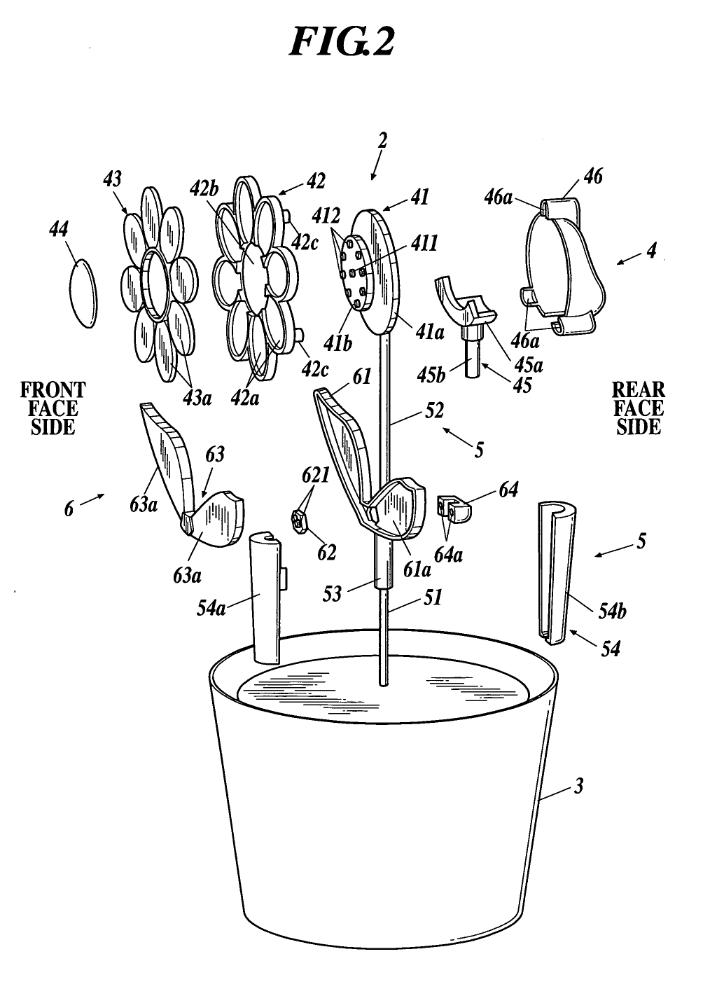

First, the plant model 2 will be described with reference to FIG. 1 and FIG. 2. Here, FIG. 1 is a front view showing the sound sensing toy 1 and FIG. 2 is an exploded perspective view of the plant model 2. Incidentally, unless otherwise specified, front face means front face of the sound sensing toy 1 and rear face means rear face of the sound sensing toy 1.

The plant model 2 includes a flower section 4, stem section 5 and a leaf section 6.

The flower section 4 is formed in a flower shape including a substantial circular plate shaped torus section 4a and a plurality of flower petal sections 4b, elliptical shaped from the front view, provided at even intervals in a radial pattern on the side circumferential face of the torus section 4a. The flower section 4 is composed of a flower section substrate 41, flower section case 42, flower section propagating section 43, torus cover 44, neck case 45 and rear face case 46. A center section of the present invention corresponds to the torus section 4a.

The flower section substrate 41 is formed in a stepped circular plate shape in which a large circular plate section 41a and a small circular plate section 41b are combined concentrically, and the flower section substrate 41 is fixed to the tip of the stem section 5 at a back face on the large circular plate section 41a side so that the front face on the small circular plate section 41b side faces the front. An outer diameter of the small circular plate section 41b of the flower section substrate 41 is formed substantially the same as an outer diameter of the torus section 4a.

Also, the flower section substrate 41 is mounted with a torus light emitting body 411 provided on a center of the front face of the small circular plate section 41b with a light emitting face facing the front and petal light emitting bodies 412 provided the same number as the petal sections 4b at even intervals in the circumferential direction near the outer circumferential section of the front face of the small circular plate section 41b with light emitting faces facing the outer diameter direction. This flower section substrate 41 is connected to a later described central control substrate 33 through an electric wire (not shown) in the stem section 5 and controls the light emission of the torus light emitting body 411 and petal light emitting bodies 412 according to content of control from the central control substrate 33. Also, the flower section substrate 41 is supplied with power from a battery (not shown) in the base 3 through the central control substrate 33.

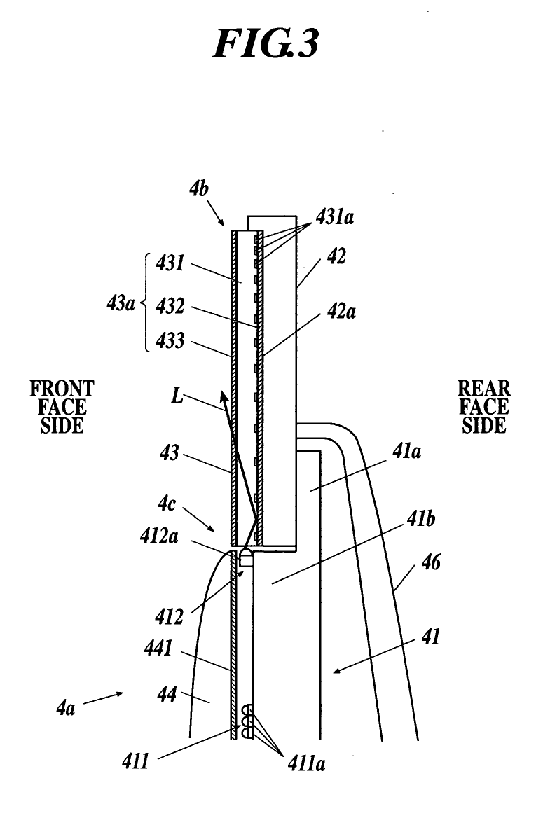

Also, the torus light emitting body 411 and petal light emitting bodies 412 are each composed including three light emitting diodes 411a and 412a (see FIG. 3) and each light emitting diode emits light of one of three colors of red, green and blue. Incidentally, in FIG. 3, three light emitting diodes 412a as the petal light emitting body 412 are provided aligned in a perpendicular direction to the plane of the drawing, and thus only one of the light emitting diodes 412a is illustrated.

As shown in FIG. 1 and FIG. 2, the flower section case 42 is a plate shaped case formed in a front face shape slightly larger than all of the petal sections 4b facing the front connected together to accommodate the flower section propagating section 43. In this flower section case 42, a petal concave section 42a is provided to fit later described flower section propagating portions 43a in each portion corresponding to the petal sections 4b on the front side. Incidentally, the flower section case 42 is formed from an opaque ABS resin, although not limited to such material.

Also, as for the flower section case 42, a hole section 42b in a circular shape from the front view to fit with the outer diameter of the small circular plate section 41b of the flower section substrate 41 penetrates in the plate thickness direction at the center from the front view, and on the rear face, three engaging shafts 42c to engage with later described engaging holes 46a of the rear face case 46 are provided standing at even intervals on the outer diameter side than the large circular plate section 41a of the flower section substrate 41. The flower section case 42 is fixed to the flower section substrate 41 by fitting the hole section 42b to the small circular plate section 41b of the flower section substrate 41 and engaging the engaging shafts 42c with the engaging holes 46a of the rear face case 46 so as to nip the flower section substrate 41. At this time, the petal light emitting bodies 412 of the flower section substrate 41 are each placed substantially center in the circumferential direction of the petal concave section 42a at a petal base portion 4c of a base of the petal section 4b.

The flower section propagating section 43 is formed in a front face shape where all of the petal sections 4b are linked by a linking circle on the inner circumference side and the flower section propagating section 43 is fixed by fitting each petal propagating portion 43a corresponding to the petal sections 4b into each petal concave section 42a of the flower section case 42.

As shown in FIG. 3, the flower section propagating section 43 is structured by a light guiding plate 431 formed in the above-described front face shape applied with a reflecting sheet 432 on the rear face side of each petal propagating portion 43a and a diffusing sheet 433 on the front face side of each petal propagating portion 43a. Here, FIG. 3 is a cross-section view showing the cross-section along arrows A-A shown in FIG. 1. On the light guiding plate 431, a large number of notches 431a are formed as reflecting dots throughout the entire face of the rear face side of the petal sections 4b and the notches 431a are formed so that the interval between each other becomes gradually smaller from the base side of the petal section 4b toward the tip side of the petal section 4b. Also, the flower section propagating section 43 is formed in a thickness so that when the flower section propagating section 43 is fixed to the flower section case 42, each petal light emitting body 412 are placed substantially center in a thickness direction (left and right direction in the figure) of the light guiding plate 431 at each petal base portion 4c.

With this structure, light L which exits from the petal light emitting bodies 412 enters the petal propagating portion 43a from a side face on the inner circumferential side of the light guiding plate 431 and repeats surface reflection to spread through the wide area of the light guiding plate 431. At this time, when the light L hits the notch 431a of the light guiding plate 431, the light L is scattered and exits externally through the diffusing sheet 433 from the front face side of the light guiding plate 431, in other words, front face side of the petal section 4b. At this time, since the interval between the notches 431a becomes gradually smaller from the base side of the petal section 4b toward the tip side of the petal section 4b, it is difficult for the light L from the petal light emitting bodies 412 to reach the tip side of the petal section 4b, and at the same time the scattering by the notches 431a become stronger, and as a result, the light L which exits from the front face side of the petal section 4b becomes gradually weaker from the base side of the petal section 4b toward the tip side of the petal section 4b. In this way, in the flower section propagating section 43, the front face side of the petal propagating portion 43a applied with the diffusing sheet 433 emits light in a gradual gradation from the base side of the petal section 4b toward the tip side of the petal section 4b. Incidentally, the light emitting section provided in the petal of the present invention includes the above described petal light emitting bodies 412 and the light guiding plate 431.

The torus cover 44 is a transparent acrylic plate in a circular shape from the front view formed with the substantially the same outer diameter as the small circular plate section 41b of the flower section substrate 41. As for the torus cover 44, one face is formed in a flat face shape and the other face is formed in a convex spherical face shape, and on the one face a diffusing sheet 441 is applied and the torus cover 44 is fixed to the flower section substrate 41 so that the one face side faces the front face of the small circular plate section 41b.

Also, as for the torus cover 44, light is emitted from the torus light emitting body 411 so that light is emitted from the convex spherical shaped face, in other words the front face side of the torus section 4a through the diffusing sheet 441.

As shown in FIG. 2, the neck case 45 is composed of a substrate supporting portion 45a to support the large circular plate section 41a and the small circular plate section 41b of the flower section substrate 41 from the bottom side and a stem supporting portion 45b in a cylindrical shape to cover the top end of the stem section 5. The neck case 45 is fixed to the connecting section between the flower section substrate 41 and the stem section 5 to strengthen the connecting section.

The rear face case 46 is formed in a substantial bowl shape open so that the large circular plate section 41a of the flower section substrate 41 can be accommodated in the thickness direction, and on the side circumferential face of the opening section, three engaging holes 46a are provided to engage with the engaging shaft 42c of the flower section case 42. The rear face case 46 accommodates the large circular plate section 41a from the rear face side and the rear face case 46 is fixed to the flower section substrate 41 by engaging the engaging shaft 42c of the flower section case 42 and the engaging hole 46a.

As shown in FIG. 1 and FIG. 2, the stem section 5 includes an iron core 51, first stem cover 52, second stem cover 53, and stem case 54. The stem section 5 supports the flower section 4 and the leaf section 6 at a predetermined height and is driven by a later described motor 32 to sway the plant model 2.

The iron core 51 is a long wire extending upward from inside the base 3 to the flower section substrate 41, and a base end side is fixed to the motor 32 in the base 3 and a tip end side is left unfixed inside the first stem cover 52 covering the iron core 51. The iron core 51 is a strengthening member to support the flower section 4 and the leaf section 6 and the iron core 51 can also rotate freely inside the first stem cover 52 and the second stem cover 53 covering the iron core 51.

The first stem cover 52 is formed by a flexible material such as fiber to cover the iron core 51 portion from the bottom edge of the leaf section 6 to the center section of the flower section 4. The first stem cover 52 is fixed to the second stem cover 53 at the leaf section 6 side and fixed to the flower section substrate 41 at the flower section 4 side.

The second stem cover 53 is formed by a flexible material such as fiber similar to that of the first stem cover 52 to cover the iron core 51 portion from the bottom edge of the leaf section 6 to a predetermined length downward.

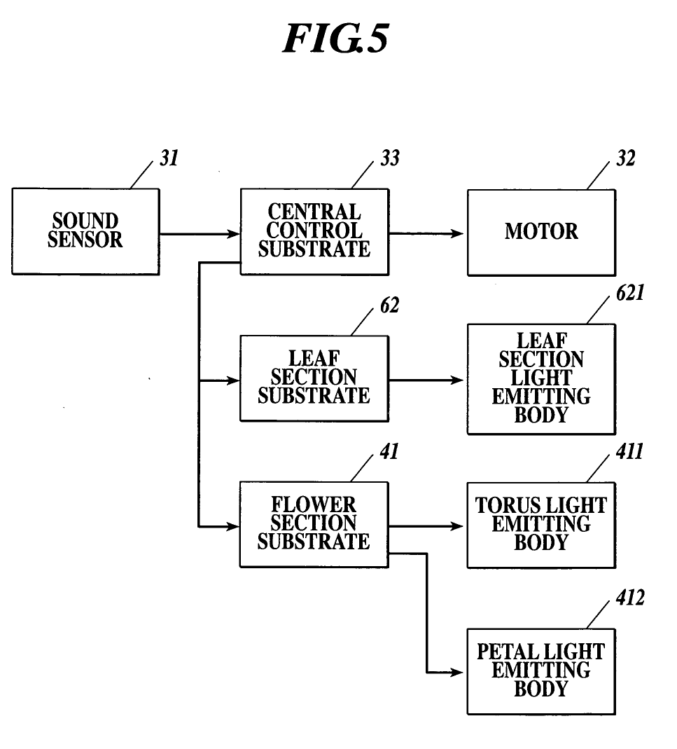

Although not shown, the first stem cover 52 and second stem cover 53 both have a double layer covering structure to cover the iron core 51 with the inner circumferential side and to cover with the outer circumferential side the electric wire (not shown) to electrically connect the later described central control substrate 33 (see FIG. 5) in the base 3 with the flower section substrate 41 and leaf section substrate 62.

The stem case 54 is a substantial cylindrical shaped case to cover the iron core 51 and the second stem cover 53 from the top face of the base 3 to the bottom edge of the leaf section 6. As for the stem case 54, one end face of the bottom side is in contact with the top face of the base 3 and the other end face of the top side is in contact with a bottom face of a later described leaf section case 61 and fixing member 64 to support the leaf section 6. The stem case 54 can be separated into two sections, first stem case 54a and second stem case 54b at a face where a central axis passes in the extending direction and is fixed so as to nip the iron core 51 and the second stem cover 53 with the first stem case 54a and the second stem case 54b. Also, the stem case 54 fixes the second stem cover 53 inside and the stem case 54 is fixed with respect to the base 3 at the bottom edge face of the stem case 54.

The leaf section 6 is formed in a shape where two leaf portions 6a representing a leaf are connected at leaf section base portions 6b at each base of the leaf portions 6a. The leaf section 6 includes a leaf section case 61, leaf section substrate 62, leaf section propagating section 63 and fixing member 64.

The leaf section case 61 is formed by two plate shaped members in the shape of the leaf portions 6a connected to each other at the leaf section base portion 6b so that the front faces of the plate shaped members face a same direction and that the plate shaped members are slightly tilted than being in line with each other within a plane orthogonal to the facing direction. The leaf section case 61 is fixed to the stem section 5 by the fixing member 64 with the front face facing the front and the tips of each leaf portion 6a pointing similarly upward. Incidentally, the leaf section case 61 is formed from an opaque ABS resin, although not limited to such material.

Also, a leaf section concave section 61a is formed in a substantial even thickness throughout the entire front face of the leaf section case 61 so that a wall with an even thickness is formed on the entire outside face of the leaf section case 61. An even deeper concave section shaped in a hexagon from the front view is formed in the connecting section of the two leaf portions 6a of the leaf section concave section 61a into which the leaf section substrate 62 is fitted, and in a center section of the deeper concave section, a hole section penetrates to the rear face side of the leaf section case 61 to connect the electric wire (not shown) to the leaf section substrate 62.

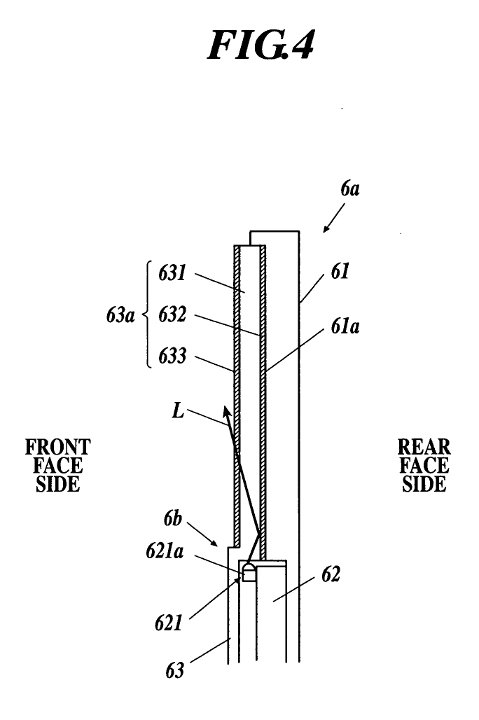

The leaf section substrate 62 is formed in a hexagonal plate shape, and is fitted with the substrate front face facing front, in a concave section provided in a connecting section of the two leaf portions 6a of the leaf section case 61. Also, the leaf section substrate 62 is mounted with two leaf section light emitting bodies 621, whose light emitting faces face the tips of each leaf portion 6a, on each leaf section base portion 6b of the substrate surface. The leaf section light emitting bodies 621 are composed each including three light emitting diodes 621a (see FIG. 4) and each light emitting diode emit light of one of three colors of red, green and blue. Incidentally, in FIG. 4, three light emitting diodes 621a as leaf section light emitting body 621 are provided aligned in a perpendicular direction to the direction shown in the diagram, and thus only one of the light emitting diodes 621a is illustrated.

The leaf section substrate 62 is connected to the later described central control substrate 33 through an electric wire (not shown) in the stem section 5 and controls the light emission of the leaf section light emitting bodies 621 according to content of control from the central control substrate 33. Also, the leaf section substrate 62 is supplied with power from a battery (not shown) in the base 3 through the central control substrate 33.

As shown in FIG. 2 and FIG. 4, the leaf section propagating section 63 is formed in a front face shape slightly smaller than a side circumferential face of the leaf section case 61 and the leaf section propagating section 63 is fixed fitted to the leaf section concave section 61a of the leaf section case 61. Here, FIG. 4 is a cross-section view showing the cross-section along arrows B-B shown in FIG. 1. As for the leaf section propagating section 63 in the connecting section of the two leaf portions 6a, on a face on the rear face side, a concave section in a shape so as the hexagonal shaped leaf section substrate 62 is pressed is formed and on the face of the front face side, a convex shape of a same shape slightly larger in size is formed, and the leaf section propagating section 63 is formed so that both leaf portions 6a are connected at the convex section.

The leaf section propagating section 63 is structured by a light guiding plate 631 formed in the above-described front face shape applied with a reflecting sheet 632 on the rear face side of each leaf section propagating portion 63a corresponding to each leaf portion 6a and a diffusing sheet 633 on the front face side of each leaf section propagating portion 63a. Also, the leaf section propagating section 63 is formed in a thickness so that when the leaf section propagating section 63 is fixed to the leaf section case 61, each leaf section light emitting body 621 are placed substantially center in a thickness direction (left and right direction in FIG. 4) of the light guiding plate 631 at each leaf section base portion 6b.

With this structure, light L which exits from the leaf section light emitting bodies 621 enters the leaf section propagating portion 63a from a side face on a leaf section base portion 6b side of the light guiding plate 631 and repeats surface reflection to spread through the wide area of the light guiding plate 631. At this time, when the light L hits the reflecting material (not shown) of the reflecting sheet 632, the light L is scattered and exits externally through the diffusing sheet 633 from the front face side of the light guiding plate 631, in other words, surface side of the leaf portion 6a. In this way, in the leaf section propagating section 63, the entire surface side of the leaf section propagating portion 63a applied with the diffusing sheet 633 emits light. Incidentally, the light emitting section provided in the leaf of the present invention includes the above described leaf section light emitting bodies 621 and the light guiding plate 631.

As shown in FIG. 2, the fixing member 64 is shaped in a substantial U-shape including a concave section with a slightly larger width than a diameter of the first stem cover 52, and on both end faces of the U-shape facing the same direction, two engaging holes 64a are provided to engage with two engaging shafts (not shown) provided standing near the leaf section base portion 6b of the rear face of the leaf section case 61. The fixing member 64 is fixed to the stem section 5 by engaging the engaging shaft of the leaf section case 61 to the engaging hole 64a so as to nip the first stem cover 52 with the concave section of the U-shape from the rear face side. At this time, the bottom side face of the fixing member 64 is in contact with and supported by the top face of the stem case 54.

Next, the base 3 will be described with reference to FIG. 2 and FIG. 5. Here, FIG. 5 is a block diagram showing a control structure of the sound sensing toy 1.

The base 3 is formed in a shape of a flowerpot including soil and supports the plant model 2 with the top section. The base 3 includes inside a sound sensor 31, motor 32 and central control substrate 33 as parts used to control motion of the plant model 2 and a battery (not shown).

The sound sensor 31 is a sensor to sense external sound at an audible band and is electrically connected to the central control substrate 33 to output whether there is any external sound or not to the central control substrate 33. Also, the sound sensor 31 is connected to the battery (not shown) and is provided with power.

The motor 32 is electrically connected to the central control substrate 33 and also the base end of the iron core 51 of the stem section 5 is connected to a motor shaft (not shown) and the motor shaft rotates to rotate the iron core 51 with respect to the extending section. Also, the motor 32 is connected to the battery (not shown) and is provided with power.

The motor 32 can, for example rotate the iron core 51 bent in a S-shape inside the first stem cover 52, second stem cover 53 and stem case 54 to sway the plant model 2 facing the front.

The central control substrate 33 is electrically connected to the sound sensor 31, motor 32, flower section substrate 41 and leaf section substrate 62 and performs predetermined control to the motor 32, flower section substrate 41 and leaf section substrate 62 according to a signal input from the sound sensor 31. Specifically, according to the sound sensed by the sound sensor 31, the central control substrate 33 controls the motor 32 to sway the plant model 2 and controls the torus light emitting body 411, petal light emitting body 412, and leaf section light emitting body 621 through the flower section substrate 41 and the leaf section substrate 62 to emit light at a predetermined light emitting pattern. The light emitting pattern is not limited and changes at least one of an emitted light color, order of emitted light, and number of emitted light for at least one of each torus light emitting body 411, petal light emitting body 412, and leaf section light emitting body 621.

Also, the central control substrate 33 includes a storage section (not shown) to store a plurality of light emitting patterns and can control the torus light emitting body 411, petal light emitting body 412, and leaf section light emitting body 621 to change the light emitting pattern according to volume of sound sensed by the sound sensor 31. Incidentally, the central control substrate 33 is connected to the battery (not shown) and is provided with power.

According to the above described sound sensing toy 1, the central control substrate 33 controls the petal light emitting body 412 of the petal base portion 4c through the flower section substrate 41 so that the front face side of the petal propagating portion 43a provided on the petal section 4b emits light in a predetermined light emitting pattern. With this, for example, a light emitting body does not have to be provided on the entire petal section 4b and by using a light guiding plate 431, the entire petal section 4b can emit light by only the petal light emitting body 412 provided on the petal base portion 4c and light can be emitted in a predetermined light emitting pattern in response to external sound. Therefore, the structure can be made at a low cost, and those using the toy can enjoy interesting light emission and interest can be enhanced.

Also, the central control substrate 33 controls the torus light emitting body 411 through the flower section substrate 41 so that the front face side of the torus cover 44 emits light in a predetermined light emitting pattern. Therefore, in addition to the petal section 4b, the front face side of the torus section 4a also emits light, and interest can be enhanced.

Also, the central control substrate 33 controls the leaf section light emitting body 621 of the leaf section base portion 6b through the leaf section substrate 62 so that the front face side of the leaf section propagating portion 63a provided on the leaf portion 6a emits light in a predetermined light emitting pattern. With this, for example, a light emitting body does not have to be provided on the entire leaf portion 6a and by using a light guiding plate 631, the entire leaf portion 6a can emit light by only the leaf section light emitting body 621 provided on the leaf section base portion 6b and light can be emitted in a predetermined light emitting pattern in response to external sound. Therefore, similar to the petal section 4b, the leaf portion 6a can also emit light with a structure at a low cost and interest can be enhanced even more.

Also, the central control substrate 33 controls the motor 32 to sway the plant model 2 based on the sound sensed by the sound sensor 31, and thus, as a response to external sound, in addition to the above described light emitting operation, the sound sensing toy 1 performs swaying motion. Therefore, interest can be enhanced even more.

Also, on the light guiding plate 431 of the flower section propagating section 43, a plurality of notches 431a as reflecting dots are formed throughout the entire face of the face on the rear face side of the petal section 4b, and the interval between the notches become gradually smaller from the base side of the petal section 4b toward the tip side of the petal section 4b, and thus the front face of the petal section 4b emits light in a gradual gradation from the base side to the tip side. Therefore, interest can be enhanced even more.

Also, the central control substrate 33 controls the torus light emitting body 411, petal light emitting body 412 and leaf section light emitting body 621 to change the light emitting pattern according to the volume of the sound sensed by the sound sensor 31, and thus different light emitting pattern can be enjoyed by changing the volume. Therefore, interest can be enhanced even more.

Also, the torus light emitting body 411, petal light emitting body 412 and leaf section light emitting body 621 each include three light emitting diode 411a, 412a and 621a which each emit a different color of light from each other, and each light emitting body can emit a variety of colors of light according to the combination of the three colors. Therefore, interest can be enhanced even more.

Also, the light emitting pattern controlled by the central control substrate 33 changes at least one of an emitted light color, order of emitted light, and number of emitted light for at least one of each torus light emitting body 411, petal light emitting body 412, and leaf section light emitting body 621 and a variety of light emitting patterns can be enjoyed and interest can be enhanced even more.

Incidentally, in the above described embodiment, the sound sensor 31 senses external sound, however the sound sensing toy 1 itself can generate sound. In this case, for example, a speaker placed inside the base 3 and a terminal which can be connected to a portable music player are provided. Then, by playing music from the music player through the speaker, the sound sensing toy 1 can emit light and sway according to the sound generated by the sound sensing toy 1 itself.

Incidentally, the notch 431a formed on the light guiding plate 431 is a reflecting dot to scatter entering light from the petal light emitting body 412, and is not limited to a notch shape. Also, a similar notch can be formed on the light guiding plate 631 of the leaf section propagating section 63 so that the leaf section propagating section 63 emits light in a gradation.

Also, the central control substrate 33 does not have to control all of the motor 32, flower section substrate 41 and leaf section substrate 62, and separate control substrates can be provided where there is a substrate to control the motor 32 and a substrate to control the flower section substrate 41 and the leaf section substrate 62.

Also, power supply to the sound sensor 31, motor 32, central control substrate 33, flower section substrate 41 and leaf section substrate 62 is not limited to the battery inside the base 3, and can be for example from an external electric outlet.

Also, on points other than those described above, the present invention is not limited to the above described embodiment and suitable changes can be made.

According to a first aspect of the preferred embodiments, there is provided a sound sensing toy including:

a plant model in a shape of a plant including a flower provided with a plurality of petals in a radial shape on a side circumferential face of a substantial circular board shaped center section;

a sound sensing section to sense external sound;

a control section to perform predetermined control according to sound sensed by the sound sensing section; and

a light emitting section provided on the plant model and including a light emitting body and light guiding plate to perform predetermined light emission by control of the control section, wherein

the light emitting section is structured with the light emitting body provided on a base portion of the petal and the light guiding plate provided on the petal so that a light from the light emitting body enters from a side face of the light guiding plate and exits from a front face side of the petal; and

the control section controls the light emitting section to emit light in a predetermined light emitting pattern according to the sound sensed by the sound sensing section.

According to this aspect, the light emitting section is structured with the light emitting body provided at the base portion of the petal and the light guiding plate provided on the petal so that the light from the light emitting body enters from the side face of the light guiding plate to exit from the front face side of the petal, and the control section controls the light emitting section to emit light in a predetermined light emitting pattern based on the sound sensed by the sound sensing section, and thus, for example a light emitting body does not need to be provided on the entire petal and by using the light guiding plate, light can be emitted from the entire petal only by the light emitting body provided on the base portion and the light can be emitted in a predetermined light emitting pattern in response to external sound. Therefore, the structure can be made at a low cost and those who use the toy can enjoy interesting light emission and interest can be enhanced.

Preferably, in the sound sensing toy, the light emitting section is structured with the light emitting body provided in the center section so that a front face side of the center section emits light.

Consequently, the light emitting section is structured so that the front face side of the center section emits light, and thus interest can be enhanced even more.

Preferably, in the sound sensing toy,

the plant model includes at least one leaf; and

the light emitting section is structured with the light emitting body provided on a base portion of the leaf and the light guiding plate provided on the leaf so that light from the light emitting body enters from a side face of the light guiding plate and exits from a front face side of the leaf.

Consequently, the light emitting section is structured with the light emitting body provided on the base portion of the leaf and the light guiding plate provided on the leaf so that the light from the light emitting body enters from the side face of the light guiding plate to exit from the front face side of the leaf and thus the leaf can emit light with a low cost structure similar to the petal. Therefore, interest can be enhanced even more.

Preferably, the sound sensing toy further includes,

a motion section to allow the plant model to perform a predetermined motion; and

a control section to control the motion section to sway the plant model based on the sound sensed by the sound sensing section.

Consequently, the sound sensing toy includes a motion section to allow the plant model to perform a predetermined motion and a control section to control the motion section to sway the plant model according to the sound sensed by the sound sensing section and thus, in response to external sound, in addition to the light emitting operation, the sound sensing toy performs swaying motion. Therefore, interest can be enhanced even more.

Preferably, in the sound sensing toy,

the light guiding plate provided on the petal includes a large number of reflecting dots formed on a face of the rear face side of the petal and formed so that the intervals between each other become gradually smaller from a base side of the petal toward the tip side, and the light guiding plate scatters the entering light from the light emitting body.

Consequently, the light guiding plate provided on the petal includes a large number of reflecting dots formed on the face of the rear face side of the petal and formed so that the interval between each other becomes gradually smaller from the base side of the petal toward the tip side of the petal to scatter entering light from the light emitting body and thus the front face of the petal emits light in a gradual gradation from the base side to the tip side. Therefore, interest can be enhanced even more.

Preferably, in the sound sensing toy,

the control section to control the light emitting section controls the light emitting section so that the predetermined light emitting pattern changes according to volume of the sound sensed by the sound sensing section.

Consequently, the control section to control the light emitting section controls the light emitting section so that the predetermined light emitting pattern is changed according to the volume of the sound sensed by the sound sensing section and thus, different light emitting patterns can be enjoyed by changing the volume. Therefore, interest can be enhanced even more.

Preferably, in the sound sensing toy,

the light emitting body includes three light emitting diodes which emit colors of light different from each other.

Consequently, the light emitting body includes three light emitting diodes, each with different light emitting color, and thus a variety of colors of light can be emitted according to the combination of the three colors. Therefore, interest can be enhanced even more.

Preferably, in the sound sensing toy,

the predetermined light emitting pattern changes at least one of an emitted light color, order of emitted light, and number of emitted light for at least one of the light emitting section.

Consequently, the predetermined light emitting pattern changes at least one of an emitted light color, order of emitted light, and number of emitted light for at least one of each light emitting section, and thus a variety of light emitting patterns can be enjoyed, and interest can be enhanced even more.

The entire disclosure of Japanese Patent Application No. 2008-122859 filed on May 9, 2008 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A sound sensing toy comprising:
a plant model in a shape of a plant including a flower provided with a plurality of petals in a radial shape on a side circumferential face of a substantial circular board shaped center section;
a sound sensing section to sense external sound;
a control section to perform predetermined control according to sound sensed by the sound sensing section; and
a light emitting section provided on the plant model and including a light emitting body and light guiding plate to perform predetermined light emission by control of the control section, wherein
the light emitting section is structured with the light emitting body provided on a base portion of the petal and the light guiding plate provided on the petal so that a light from the light emitting body enters from a side face of the light guiding plate and exits from a front face side of the petal; and
the control section controls the light emitting section to emit light in a predetermined light emitting pattern according to the sound sensed by the sound sensing section.

2. The sound sensing toy according to claim 1, wherein,
the light emitting section is structured with the light emitting body provided in the center section so that a front face side of the center section emits light.

3. The sound sensing toy according to claim 1, wherein,
the plant model includes at least one leaf; and
the light emitting section is structured with the light emitting body provided on a base portion of the leaf and the light guiding plate provided on the leaf so that light from the light emitting body enters from a side face of the light guiding plate and exits from a front face side of the leaf.

4. The sound sensing toy according to claim 1, further comprising:
a motion section to allow the plant model to perform a predetermined motion; and
a control section to control the motion section to sway the plant model based on the sound sensed by the sound sensing section.

5. The sound sensing toy according to claim 1, wherein,
the light guiding plate provided on the petal includes a large number of reflecting dots formed on a face of the rear face side of the petal and formed so that the intervals between each other become gradually smaller from a base side of the petal toward the tip side, and the light guiding plate scatters the entering light from the light emitting body.

6. The sound sensing toy according to claim 1, wherein,
the control section to control the light emitting section controls the light emitting section so that the predetermined light emitting pattern changes according to volume of the sound sensed by the sound sensing section.

7. The sound sensing toy according to claim 1, wherein
the light emitting body includes three light emitting diodes which emit colors of light different from each other.

8. The sound sensing toy according to claim 1, wherein
the predetermined light emitting pattern changes at least one of an emitted light color, order of emitted light, and number of emitted light for at least one of the light emitting section.
